(19) United States
(12) Patent Application Publication
(10) Pub. No.: US 2012/0310861 A1
(43) Pub. Date: Dec. 6, 2012

(54) UTILITY CALCULATION AND PRICING SYSTEM AND METHOD

(76) Inventors: Ankur Varma, San Francisco, CA (US); Matthew J. Smith, San Francisco, CA (US); Peter Santangeli, Los Gatos, CA (US); Gary Grossman, San Francisco, CA (US)

(21) Appl. No.: 13/369,958

(22) Filed: Feb. 9, 2012

Related U.S. Application Data
(60) Provisional application No. 61/492,288, filed on Jun. 1, 2011.

(51) Int. Cl. G06Q 40/00

(52) U.S. Cl. 705/412

(57) ABSTRACT

A method of controlling usage of a commodity. The method includes monitoring, by an electronic device, a usage of the commodity, communicating, by the electronic device, the usage of the commodity to a fully-loaded cost engine at a remote location, determining, by the fully-loaded cost engine, a fully-loaded price for a commodity, communicating the fully-loaded price to a device, and operating a commodity-using device based on the fully-loaded cost and a commodity-consumption strategy.

### RELATED APPLICATION

The present application claims the benefit of prior-filed co-pending U.S. Provisional Patent Application No. 61/492,288, filed on Jun. 1, 2011, the entire contents of which are hereby incorporated by reference.

### BACKGROUND

The invention relates to systems and methods for modifying usage of a commodity, specifically, systems and methods for informing an end-user or a local device of a fully-loaded cost of the commodity such that the user or device can determine how to control devices that use the commodity.

Commodity providers are increasingly employing systems and methods to reduce usage of commodities during peak usage periods. For example, electric utilities have implemented systems and methods to turn off certain devices (e.g., washers and dryers) during peak usage periods, such as at peak air conditioning usage periods on hot days (e.g., mid-afternoon when people return home from work and turn on their air conditioners). By reducing demand during peak periods, commodity providers are able to reduce the need for new production facilities to meet peak needs when existing facilities are adequate for non-peak periods.

A variety of systems and methods have been developed to motivate customers to reduce consumption during peak periods. For example, time of use pricing, variable peak pricing, real-time pricing, etc., are all gaining market acceptance, not only for commercial and industrial customers, but also for residential customers.

### SUMMARY

In one embodiment, the invention provides a method of controlling usage of a commodity at a first location. The method includes monitoring, by an electronic device, a usage of the commodity at the first location, communicating, by the electronic device, the usage of the commodity to a fully-loaded cost engine at a remote location, determining, by the fully-loaded cost engine, a fully-loaded price for a commodity, communicating the fully-loaded price to a device at the first location, and operating a commodity-using device at the first location based on the fully-loaded cost and a commodity-consumption strategy.

In another embodiment, the invention provides a system for controlling usage of a commodity. The system includes an electronic device, a fully-loaded cost engine, and a smart device. The electronic device is configured to monitor usage of the commodity. The fully-loaded cost engine is configured to receive an indication of the usage of the commodity from the electronic device and to calculate a fully-loaded cost of the commodity. The smart device is configured to receive the fully-loaded cost of the commodity from the fully-loaded cost engine and to operate a commodity-using device based on the fully-loaded cost and a commodity-consumption strategy.

In another embodiment, the invention provides system for controlling usage of a commodity. The system includes an electronic device, a module, and a smart device. The electronic device is configured to monitor usage of the commodity. The module is configured to receive an indication of the usage of the commodity from the electronic device and to calculate a projected cost of the commodity for a present billing period, the projected cost including extrapolated projected variable costs of the commodity for the present billing period. The smart device is configured to receive the projected cost of the commodity from the module and to operate a commodity-using device based on the projected cost and a commodity-consumption strategy.

Other aspects of the invention will become apparent by consideration of the detailed description and accompanying drawings.

### BRIEF DESCRIPTION OF THE DRAWINGS

FIG. 1 is a schematic illustration of a utility grid topology.

FIG. 2 is a schematic illustration of a utility network topology for the utility grid of FIG. 1.

FIG. 3 is a schematic illustration of a home area network.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

As should be apparent to one of ordinary skill in the art, the systems and networks shown in the figures are models of what actual systems or networks might be like. As noted, many of the modules and logic structures described are capable of being implemented in software executed by a microprocessor or a similar device or of being implemented in hardware using a variety of components including, for example, application specific integrated circuits (“ASICs”). Terms like “processor” may include or refer to both hardware and/or software. Furthermore, throughout the specification capitalized terms are used. Such terms are used to conform to common practices and to help correlate the description with the coding examples, equations, and/or drawings. However, no specific meaning is implied or should be inferred simply due to the use of capitalization. Thus, the invention is not limited to the specific examples or terminology or to any specific hardware or software implementation or combination of software or hardware.

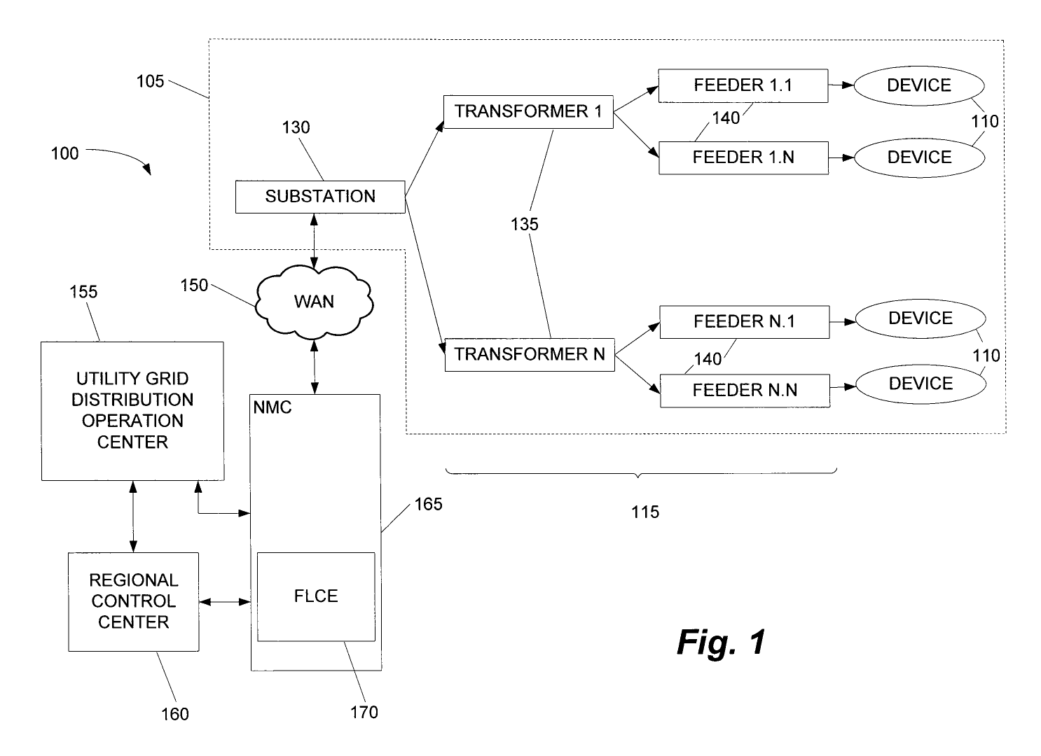

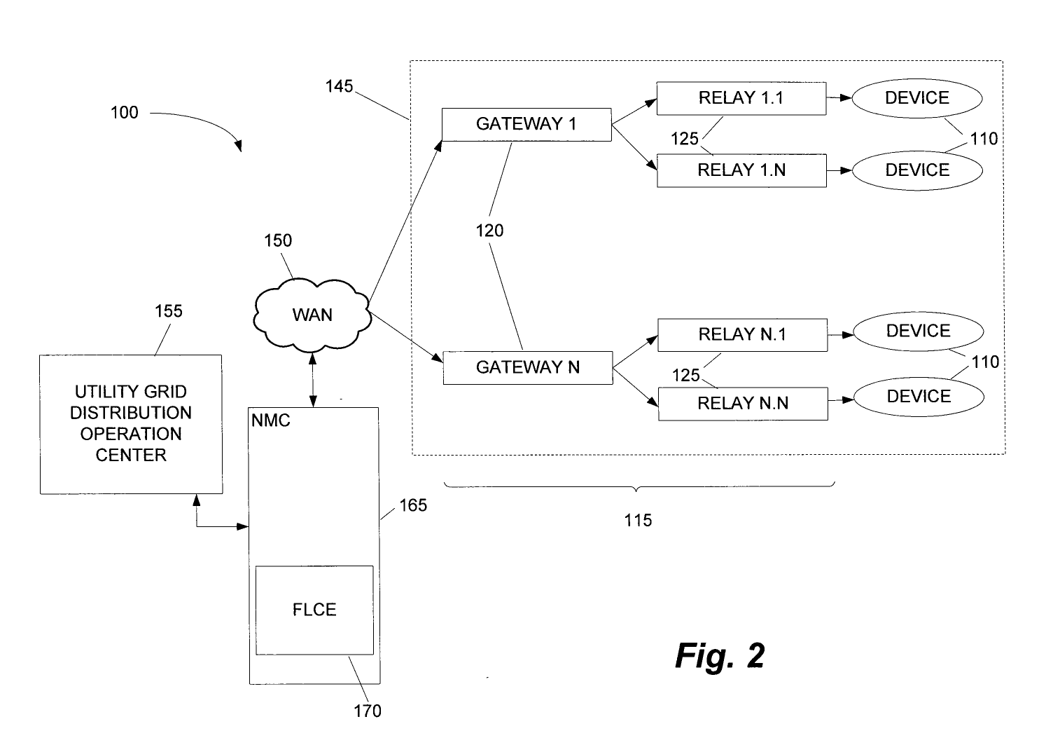

FIGS. 1 and 2 illustrate a commodity distribution system 100 for distributing and managing the distribution of the commodity in a utility grid or utility network 105 having a number of electronic utility devices 110 deployed along product distribution pathways of the utility grid 105. The electronic utility devices 110 monitor at least one parameter associated with the product distribution pathways. While reference is made herein to an electric utility and a utility grid 105 for power distribution, it should be understood that the systems and methods described herein can also or alternatively be used with other utilities, such as, for example, water, gas, and/or other measurable and widely distributed services, and also in any other instrumented electrical devices (e.g., street lights).

As shown in FIGS. 1 and 2, the utility grid 105 (see FIG. 1 in particular) is deployed by a utility company in a topology designed to serve customers in a service area, with a distributed hierarchical network of network infrastructure devices 115 (e.g., communication nodes, gateways 120, relays 125, substations 130, transformers 135, and feeder stations 140), a utility grid distribution operations center 155, and regional control centers 160. A communications network can facilitate communications between the elements of the commodity delivery system 100. As shown in FIGS. 1 and 2, the communications network can include a first network (e.g., a local area network (“LAN”)) 145 (see FIG. 2, in particular), which can overlay and provide communication between elements of the utility grid 105, and a second network 150, e.g., a wide area network (“WAN”), which can link the electronic utility devices 110, relays 125, and gateways 120 in the field with the utility grid distribution operation center 155 and a network interface of a network management center 165 (“NMC”) to provide automated meter reading, grid control and monitoring operations. In other embodiments, a single network or three or more networks can facilitate communications between the elements of the commodity delivery system 100 (e.g., the network infrastructure devices 115, the utility grid distribution operations center 155, and the NMC 165).

In the illustrated embodiment, the NMC 165 can communicate with gateways 120 over the second network 150 (see FIG. 2), and the gateways 120 can communicate with relays 125 and/or electronic utility devices 110 over the first network 145. (As used herein and in the appended claims, the terms “access point” and “gateway” are used interchangeably.) It should be noted that the first network 145 may cover the utility grid area and its topology, and may or may not match the grid infrastructure topology. In some embodiments, the electronic utility devices 110, the relays 125, and gateways 120, the NMC 165, an agent of the NMC 165, and/or the network infrastructure devices 115 include frequency-hopping spread spectrum communication protocol capability, broadband communication capability, IPv4 communication capability, IPv6 communication capability, modulation, direct-sequence spread spectrum modulation, and/or orthogonal frequency-division multiplexing modulation capability.

As shown in FIG. 2, the gateways 120, relays 125 and/or one or more of the electronic utility devices 110 can act as an agent of the NMC 165 to extend the operational reach of the first network 145 and/or the second network 150. In various applications, the relays 125 can be placed high for best line-of-sight to electronic utility devices 110. Also, several electronic utility devices 110 can be associated with each relay 125, and several relays 125 can be associated with a gateway 120. In some embodiments, an electronic utility device 110 can also or alternatively function as a relay 125. For example, the electronic utility devices 110 can include a network interface card (“NIC”) that enables the electronic utility devices 110 to maintain two-way communications with the NMC 165 via relays 125 and/or gateways 120. In some embodiments, the electronic utility devices 110 and/or the relays 125 may have direct two-way communications over a private network such that the electronic utility devices 110 can communicate with other elements of the commodity distribution system 100 without sending transmissions through the gateways 120 and/or the first network 150.

The gateways 120 can execute schedules (i.e., a listing of which electronic utility devices 110 are read including, for example, a start date and time, an optional end date and time), collect data from the electronic utility devices 110 over the first network 145, and/or forward read data upstream to the NMC 165. The gateways 120 can also or alternatively perform network management functions such as route calculation and reachability pings or queries, which test the reachability of electronic utility devices 110 on the first and second networks 145, 150.

The NMC 165 includes a fully-loaded cost engine (“FLCE”) 170 (e.g., a module of the NMC 165). The fully-loaded cost engine 170 calculates the fully-loaded price (i.e., a projected cost) of the commodity for customers for a current billing period. The fully-loaded price includes a base rate (e.g., $/kWh) and customer and/or utility specific billing determinants such as taxes, credits, energy use surcharges (e.g., peak demand charges, time-of-day surcharges, etc.), transmission and distribution (T&D) costs, etc. The fully-loaded cost engine 170 continually updates the fully-loaded price of energy as additional parameters are learned through the system 100 (e.g., usage info from the electronic device 110). For example, many rate plans overlay a surcharge on the base rate that depends on the actual monthly usage. Since this usage is not known until the end of the month, the fully-loaded cost engine 170 extrapolates and updates the price of the commodity over time. Additionally, the fully-loaded cost engine 170 communicates the fully-loaded price of the commodity to the electronic devices 110. Each customer can have a unique cost structure; therefore, the fully-loaded cost engine 170 can calculate and communicate a unique fully-loaded price to each electronic device 110.

The fully-loaded cost engine 170 may include instructions stored on a non-transitory computer readable medium that, when executed by a processor, cause the processor to carry out the functionality of the software described herein. In some embodiments, the fully-loaded cost engine 170 is implemented in hardware (e.g., an application specific integrated circuit (ASIC) or field programmable gate array (FPGA)) or in a combination of hardware and software (e.g., a processor or microcontroller including or with access to instructions stored in a computer-readable medium). In some embodiments, the fully-loaded cost engine 170 is implemented as a plurality of distributed devices, that is, the fully-loaded cost engine 170 is not part of the NMC 165, but rather located elsewhere in the system 100 (e.g., in the electronic devices 110 and/or in the relays 125, etc.).

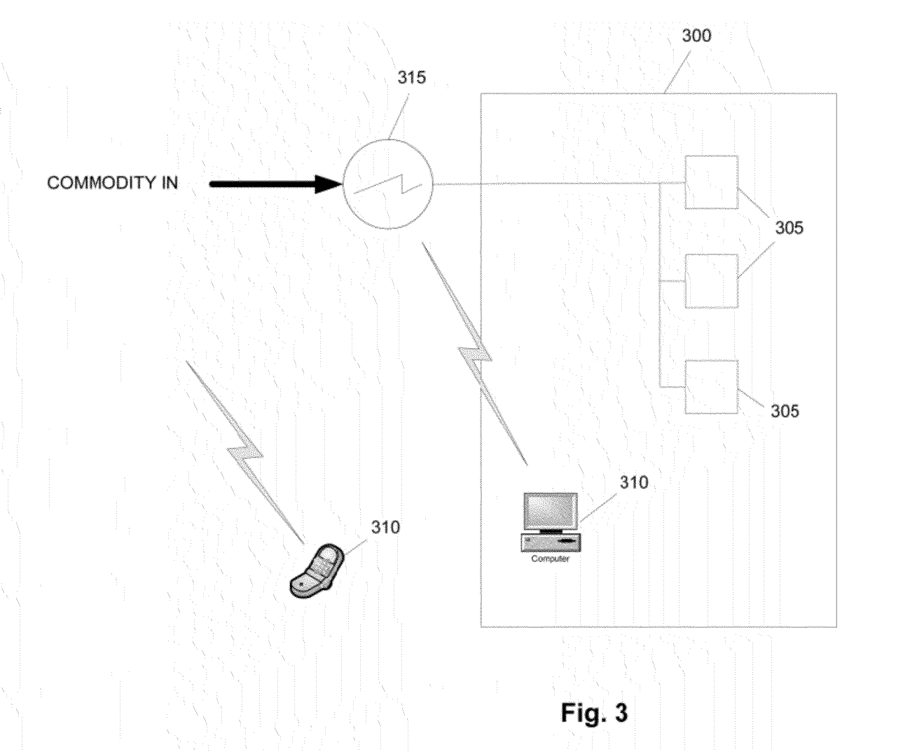

FIG. 3 shows an exemplary home-area network 300 (HAN). The HAN 300 can include one or more smart devices 305 and/or one or more communication interfaces 310. The smart devices can include devices such as smart power outlets, smart appliances, and the like. The smart devices 305 are capable of receiving messages from the network 145, and can control the usage of the commodity through the devices based on the messages. The communication interfaces 310 receive messages from the network 145, and provide information from the messages to a user. The communication interface 310 can include devices such as cell phones (e.g., for receiving texts, voice messages, or e-mails), computing devices (e.g., for receiving e-mails or other types of notices), and/or an alarm (e.g., a flashing LED or a message on a thermostat).

The smart devices 305 receive messages from a utility meter 315 or other device(s) (e.g., the relays 125, the fully-loaded cost engine 170 directly, etc.) of the commodity distribution system 100. Also, communications in the HAN 300 can be wireless (e.g., WiFi, Bluetooth, etc.), power line carrier, hard wired, or any suitable communication method.

In the embodiment shown, the fully-loaded cost engine 170 communicates the fully-loaded cost of the commodity to the utility meter 315 (i.e., electronic device 110). In some embodiments, the meter 315 makes determinations, based on a commodity-consumption strategy, as to which devices 305 should be allowed to use the commodity based on the fully-loaded cost. The meter 315 then communicates with the devices 305 to enable or disable usage of the commodity. In some embodiments, the meter 315 or other devices in the commodity delivery system 100 communicate the fully-loaded cost to the smart devices 305 which then determine whether to use the commodity or not.

Various embodiments exist where different devices act as a controller, controlling operation of a device based on the fully-loaded cost of the commodity. For example, the meter 315 can function as a controller, turning devices on or off at the location. In addition, one or more smart devices 305 can receive the fully-loaded cost information and control themselves. In some HANs 300, the meter 315 controls some devices, while some smart devices 305 control themselves.

In addition to communicating the fully-loaded price of the commodity to the meter 315 and/or the smart devices 305, the fully-loaded cost engine 170 can provide fully-loaded cost information to one or more of the communication interfaces 310. For example, the fully-loaded cost (or some other information related to the fully-loaded cost) can be sent as a text message to a cell phone, enabling the user to decide, for example, whether to turn up the temperature on an air conditioning system. The information can be sent when the fully-loaded cost changes, at regular pre-set times, or in other manners. In some embodiments, the user may obtain the fully-loaded cost information by sending a message (e.g., a text, an email, or in any other suitable manner) to the FLCE 170 (e.g., via a communication interface 310) requesting the current fully-loaded cost information for the commodity.

Some customers may participate in Demand Response programs (i.e., a commodity-consumption strategy) which provide limits on the usage of a commodity (e.g., based on time-of-day, peak demand, etc.). Devices that participate in Demand Response programs can be set up to automatically respond to a price conveyed to it either by the utility meter 315 and/or other device, or by other mechanisms for communicating the fully-loaded price, as described above. For instance, the FLCE 170 can calculate the fully-loaded price for the next hour or other time interval for a specific customer (e.g., the customer associated with HAN 300). The meter 315 communicates the fully-loaded price to the HAN 300 and one or more smart devices therein (e.g., smart device 305). The one or more smart devices 305 take action based on pre-defined or user defined commodity-consumption strategy.

By using the fully-loaded price, the end customer is presented with the true cost of energy, and; thereby, devices can take action that is more meaningful. For instance, the base cost of the commodity may be 5 c/kwh; but the fully-loaded price may be 7 c/kwh. The fine grained difference here may cause the downstream devices to respond differently. For example, the different prices may fall within various thresholds and configurations associated with the end customer, resulting in a smart device 305 taking action at different times (e.g., at night, rather than during the day) and/or using different techniques (e.g. using a reduced power consumption mode, using cold water rather than hot water for a wash cycle, and the like).

Although only one HAN 300 and utility meter 315 are depicted in FIG. 3, in some embodiments, the fully-loaded cost engine 170 receives usage information from, and provides pricing information to, multiple HANs 300 via utility meters 315 and/or network infrastructure devices 115.

Various features and advantages of the invention are set forth in the following claims.

What is claimed is:

1. A method of controlling usage of a commodity at a first location, the method comprising:
monitoring, by an electronic device, a usage of the commodity;
communicating, by the electronic device, the usage of the commodity to a fully-loaded cost engine at a second location remote from the first location;
determining, by the fully-loaded cost engine, a fully-loaded price for a commodity at the first location;
communicating the fully-loaded price to a device at the first location; and
operating a commodity-using device at the first location based on the fully-loaded cost and a commodity-consumption strategy.

2. The method of claim 1, wherein the device is a utility meter.

3. The method of claim 2, wherein the utility meter acts as a controller, and is configured to control operation of the commodity-using device.

4. The method of claim 1, wherein a smart appliance is the device and the commodity-using device.

5. The method of claim 4, wherein the smart appliance acts as a controller, and is configured to control its own operation based on the fully-loaded cost and the commodity-consumption strategy.

6. The method of claim 1, wherein the device is a communications interface.

7. The method of claim 6, further comprising requesting, by the communications interface, the fully-loaded price from the fully-loaded cost engine.

8. The method of claim 1, wherein the fully-loaded price includes a variable cost.

9. The method of claim 8, wherein the variable cost includes at least one of a peak demand surcharge, a monthly usage surcharge, and a time-of-day surcharge.

10. A system for controlling usage of a commodity, the system comprising:
an electronic device configured to monitor usage of the commodity;
a fully-loaded cost engine configured to receive an indication of the usage of the commodity from the electronic device and to calculate a fully-loaded cost of the commodity;
a smart device configured to receive the fully-loaded cost of the commodity from the fully-loaded cost engine and to operate a commodity-using device based on the fully-loaded cost and a commodity-consumption strategy.

11. The system of claim 10, further comprising a computing device including a non-transitory computer readable medium, the non-transitory computer readable medium including the fully-loaded cost engine.

12. The system of claim 10, wherein the device is a utility meter.

13. The system of claim 12, wherein the utility meter acts as a controller, and is configured to control the operation of the commodity-using device.

14. The system of claim 10, wherein a smart appliance is the device and the commodity-using device.

15. The system of claim 14, wherein the smart appliance acts as a controller, and is configured to control its own operation based on the fully-loaded cost and a commodity-consumption strategy.

16. The system of claim 10, wherein the device is a communications interface.

17. The system of claim 16, wherein the communications interface is configured to request the fully-loaded price from the fully-loaded cost engine.

18. The system of claim 10, wherein the fully-loaded price includes a variable cost.

19. The system of claim 18, wherein the variable cost includes at least one of a peak demand surcharge, a monthly usage surcharge, and a time-of-day surcharge.

20. A system for controlling usage of a commodity, the system comprising:
an electronic device configured to monitor usage of the commodity;
a module configured to receive an indication of the usage of the commodity from the electronic device and to calculate a projected cost of the commodity for a present billing period, the projected cost including extrapolated projected variable costs of the commodity for the present billing period;
a smart device configured to receive the projected cost of the commodity from the module and to operate a commodity-using device based on the projected cost and a commodity-consumption strategy.

21. The system of claim 20, wherein the projected cost of the commodity includes one or more of a base rate, taxes, credits, energy use surcharges, peak demand charges, time-of-day surcharges, and transmission and distribution costs.
